(19) United States
(12) Patent Application Publication
(10) Pub. No.: US 2025/0271348 A1
(43) Pub. Date: Aug. 28, 2025

(54) METHOD FOR LOCATION AND SPECTRAL IMAGING OF MICROPARTICLES, AND ASSOCIATED SYSTEM

(71) Applicant: HORIBA FRANCE SAS, PALAISEAU (FR)

(72) Inventors: Damien CANNESON, Lille (FR); Emmanuel FROIGNEUX, Picauville (FR); Sébastien Alexandre André LADEN, Bondues (FR)

(21) Appl. No.: 19/064,084

(22) Filed: Feb. 26, 2025

(30) Foreign Application Priority Data
Feb. 27, 2024 (FR) 2401923

(51) Int. Cl. G01N 15/1434; G01N 15/1429

(52) U.S. Cl. CPC G01N 15/1434; G01N 15/1429; G01N 2015/144

(57) ABSTRACT

The invention relates to a method for spatial location and spectral imaging of microparticles (202) in a sample (200). This method comprises the following steps:
A) illuminating the sample by an annular lighting cone (124) coming from a light beam partly reflected by an annular mirror (13) and focused by a peripheral region (142) of a dark-field microscope objective (14),
B) recording a dark-field microscopy image, the latter being collected by a central region (144) of the objective,
C) locating points of interest in the image,
D) extracting coordinates of the points of interest, in order to form a list of points,
E) moving the sample, to scan one of the extracted points,
F) illuminating the point on the sample using a laser beam transmitted through the annular mirror and focused by the central region of the dark-field microscope objective,
G) collecting an emitted Raman spectrum by the central region of the objective.
   The invention therefore relates to an associated system.

### TECHNICAL FIELD

The present invention generally relates to the field of microparticle analysis by spectral imaging.

More particularly, it relates to a method for location and spectral imaging of transparent microparticles, as well as an associated system.

The invention finds a particularly advantageous application in the tracking and fast spectral imaging of transparent microparticles scattered within a sample of macroscopic size.

### STATE OF THE ART

The detection and identification of the chemical nature of solid particles of micrometric size, commonly called microparticles, is a subject of interest to many industries and/or applications. For example, the study of plastic microparticles, which involves detecting, quantifying and identifying them, is essential in fields such as environmental science, food industry, etc. Within the framework of such studies, a sample of macroscopic size, extending over a few square millimetres, or even a few square centimetres, is taken from a medium to provide a representative overview of that medium. Such a sample can for example be in liquid or gaseous form, and include solid microparticles in suspension, or in the form of a powder of solid microparticles.

Measurement systems have been developed in order to meet this analysis need. Spectral imaging systems have thus been proposed, associating a so-called full-field microscopy imaging modality, used for the spatial location of microparticles, with a spectral analysis modality, most often by spot analysis using a laser source in order to record a spectrum of each microparticle, this spot analysis making it possible to trace the chemical composition of the microparticles analysed.

However, the image field of view of such spectral imaging systems remains limited to rectangular areas of a few millimetres by a few millimetres, or even less, when high-magnification microscope objectives are used, in order to spatially resolve the micrometric particles under study. Therefore, scanning the whole surface of the sample to locate microparticles requires making a mosaic of the sample, which is then moved using a stage, each tesserae or tile of the mosaic being of the size of the image field of view of the imaging system, whose dimensions depend in particular on the microscope objective and/or the image sensor.

According to a method commonly described as static, the set of tiles of a mosaic representative of a sample are acquired by full-field microscopy, before proceeding, in a second time, to the spot analysis by laser spectroscopy. Therefore, the sample is first fully imaged, before its spectral analysis.

Typically, a macroscopic sample requires the acquisition and processing of a mosaic containing a few millions of tiles. Such an image size requires a compression of the image quality of the mosaic in order to store it for extraction of the coordinates of the various microparticles. This extraction is then followed by a spot analysis by spectral acquisition on the extracted coordinate points. This image quality compression is however made to the detriment of spatial resolution.

A dynamic approach has been proposed to remedy the spatial resolution deterioration. This dynamic approach involves extraction of the microparticle coordinates, tile by tile, and the acquisition of spectra on the fly, on each tile, before going to the following tile. This dynamic approach offers multiple advantages, including a reduction of the image size, because only the coordinates of interest are kept, rather than an entire tile. However, this approach multiplies acquisition times when switching from the imaging modality to the spectral analysis modality for each tile.

Known solutions for observing single-particle are for instance described in Shaochuang Liu, Yilun Ying, Yitao Long. Rapid ultrasensitive monitoring the single-particle surface-enhanced Raman scattering (SERS) using a dark-field microspectroscopy assisted system [J]. Chin. Chem. Lett., 2020, 31(2): 473-475, while a micro-spectrometry measurement method is described in WO 2018/138098 A1.

### DISCLOSURE OF THE INVENTION

In order to remedy the above-mentioned drawbacks of the state of the art, the present invention proposes to adapt the dynamic approach in order to allow both the location and the spectral analysis of microparticles without motorized mechanical part switching, thus reducing acquisition times.

More particularly, it is proposed according to the invention a method for spatial location in an image and spectral analysis of microparticles in a sample by a microscopy system, the method comprising the following steps:
A) illuminating an area of the sample using an annular lighting cone, the annular lighting cone coming from a white light beam partly reflected by an annular mirror and focused by a peripheral region of a dark-field microscope objective,
B) recording a first dark-field microscopy image on a field of view included in the illuminated area of the sample, the first dark-field image being collected by a central region of the dark-field microscope objective,
C) locating the microparticles in the first dark-field image,
D) extracting the coordinates of the points corresponding to microparticles inside the dark-field image recorded, so as to form a list of points,
E) moving the sample to make an optical axis of the dark-field microscope objective coincide with a point from the list of points,
F) illuminating a measurement point on the sample using an excitation laser beam transmitted through the annular mirror and focused by the central region of the dark-field microscope objective, the measurement point coinciding with the point from the list of points,
G) collecting a Raman spectrum emitted from the measurement point, the Raman spectrum being collected by the central region of the dark-field microscope objective.

Therefore, thanks to the invention, no mechanical switching is required to switch from one microscopy modality to another in the context of a dynamic approach. This property is advantageous for samples of large size in relation to a microscope's field of view, in the context of a dynamic approach as defined in introduction. This dynamic approach having been introduced in order in particular to avoid using a compression of the spatial resolution, a compression that is necessary in order to process a large volume of data, given the size of the samples studied. However, the necessity to switch a motorized mechanical part inside each tile, in order to proceed to the acquisition of a wide-field image then to an acquisition of spot spectra inside the image, led to incompressible idle times of the order of 5 seconds per tile. When scaled to millimetre or even centimetre samples, these idle times represent hours. Thanks to the invention, the advantages of the dynamic approach, i.e. an accurate positioning at the sample scale, a high spatial resolution as well as a measurement that is little affected by environmental variations, are preserved, while eliminating the prohibitive mechanical switching times. This elimination of the mechanical switching times thus removes an important obstacle to the use of the dynamic approach on samples, in particular, large samples.

Moreover, due to the invention, the mechanical reliability of the system is improved. Indeed, moving parts are a potential source of misalignment, or even system obsolescence.

The proposed solution not only eliminates these idle times, which represents a significant time saving and increases system reliability, but also advantageously combines the properties of the two chosen modalities, dark-field microscopy and Raman microspectrometry, also called Raman micropsectroscopy. On the one hand, it results therefrom a solution without mechanical switching and without signal loss, to within the optical losses, the totality of the Raman signal collected in epi-detection arriving to the spectrometer. On the other hand, the study of large samples comprising microparticles with low light absorption is facilitated.

Other non-limiting and advantageous features of the method according to the invention, taken individually or according to all the technically possible combinations, are the following:
steps A) and F) are carried out simultaneously, an area is illuminated on the sample by the peripheral region of the dark-field microscope objective, whereas a measurement point inside the area is illuminated by the central region of the dark-field microscope objective,
the measurement point is located along an optical axis of the central region of the dark-field microscope objective,
a field of greater size than the image field of view is reconstructed by a mosaic of dark-field microscopy images, these dark-field microscopy images corresponding to tiles of the mosaic,
a positioning of each tile of the mosaic is predefined upstream of the process,
steps E), F) and G) are repeated until all points from the list of points extracted on a given tile have been scanned, before proceeding to a step of moving the sample in order to centre the field of view of the dark-field microscope objective to another tile of the mosaic and to resume the process from step A), in order to record another dark-field microscopy image,
for each tile of the mosaic, the list of points includes a determined number of points,
a positioning of at least one tile of the mosaic is established as a function of the coordinates of a point from the list of points,
after the moving in step E) to make the optical axis of the dark-field microscope objective coincide with a point from the list of points, steps A), B), C), D), F) and G) are carried out, a new dark-field microscopy image, corresponding to a new tile of the mosaic, and a Raman spectrum emitted from the measurement point, are recorded, these steps being followed by another displacement of the sample to make the optical axis of the dark-field microscope objective coincide with another point from the list of points,
additional points extracted from the new dark-field microscopy image recorded after the moving of step F) are added to the list of points to be scanned.

The invention also relates to a system for spatial location in an image and spectral analysis of microparticles, comprising an optical microscope, a laser source, a white light source, an image sensor, a spectrometer and a control unit, the latter comprising a image processing unit, the optical microscope comprising a sample holder mounted on a displacement stage, the sample holder being adapted to receive a sample, the system being characterized in that it comprises an optical system comprising an annular mirror, a dark-field microscope objective, the optical system being arranged between the laser source, the white light source and the sample holder, the dark-field microscope objective having a central region and a peripheral region,
the annular mirror is configured to reflect part of white light beam emitted by the white light source towards the peripheral region of the dark-field microscope objective, and transmit an excitation laser beam emitted by the laser source towards the central region of the dark-field microscope objective,
the dark-field microscope objective is adapted to transmit the part of the white light beam using its peripheral region towards the sample holder and to transmit the excitation laser beam via its central region towards the sample holder,
the dark-field microscope objective is adapted to focus the part of the light beam in order to illuminate a first area of a sample on the sample holder using an annular lighting cone and the dark-field microscope objective is adapted to focus the excitation laser beam to a measurement point included in the first area,
the central region of the dark-field microscope objective is adapted to collect a dark-field microscopy image on an image field of view included in the first illuminated area, the dark-field microscopy image being recorded using the image sensor,
the image processing unit is adapted to locate potential microparticles, and to extract from the dark-field microscopy image coordinates of the points associated with these microparticles, in order to establish a list of points,
the displacement stage is configured to move the sample holder, in order to make the measurement point coincide with a point from the list of points or in order to place the image field of view of the dark-field microscope objective to another area at least partially different from the first area,
the central region of the dark-field microscope objective is also adapted to collect a Raman spectrum generated from the measurement point, the Raman spectrum being recorded by a Raman spectrometer.

### DETAILED DESCRIPTION OF THE INVENTION

Moreover, various other features of the invention emerge from the appended description made with reference to the drawings that illustrate non-limiting embodiments of the invention, and wherein:

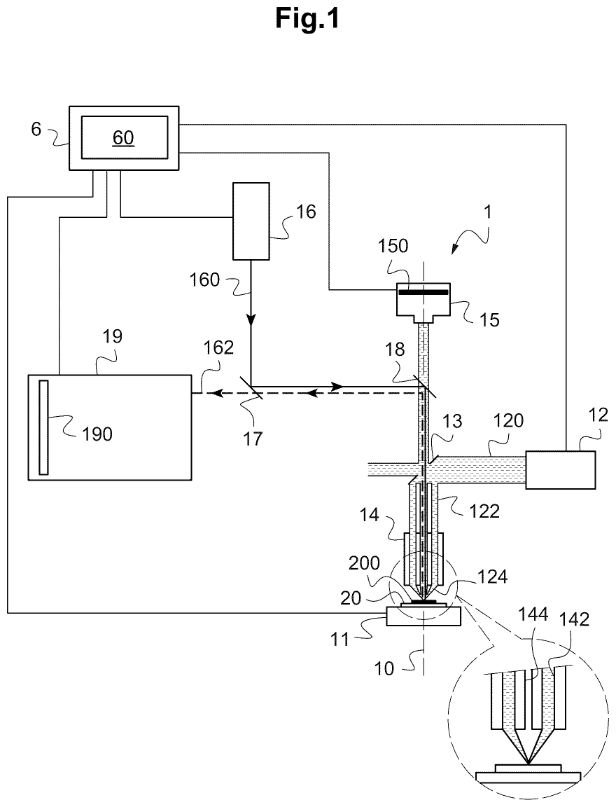

FIG. 1 schematically illustrates an optical microscopy system adapted to implement a method for spatial location and spectral analysis of microparticles in a sample,

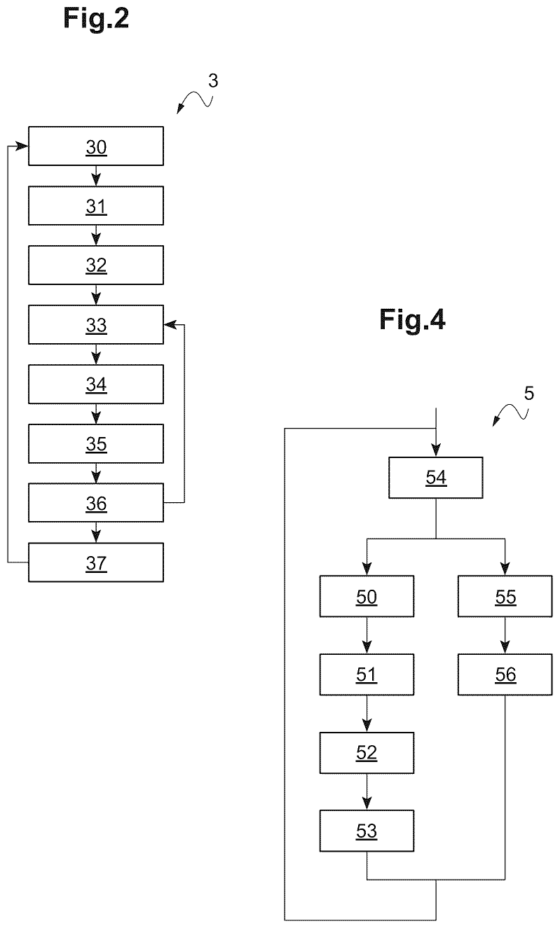

FIG. 2 is a block diagram showing a first embodiment of the method of the invention,

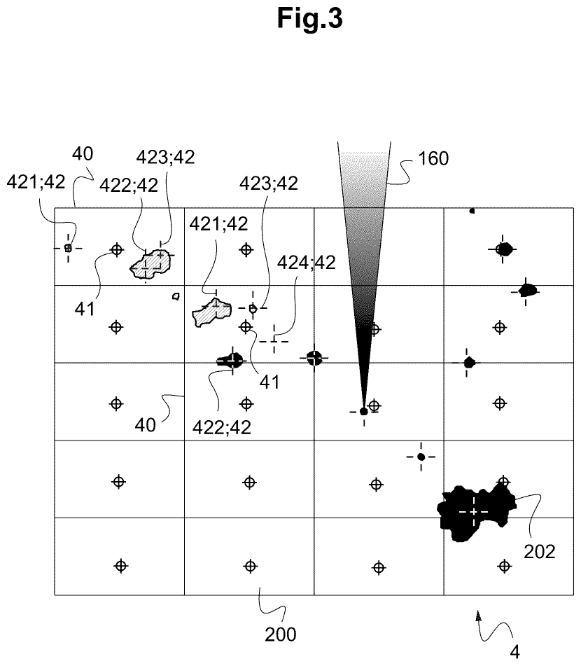

FIG. 3 shows an example of mosaic comprising a plurality of tiles, each tile corresponding to an image recorded using the method described in relation to FIG. 2,

FIG. 4 is a block diagram showing a second embodiment of the method of the invention,

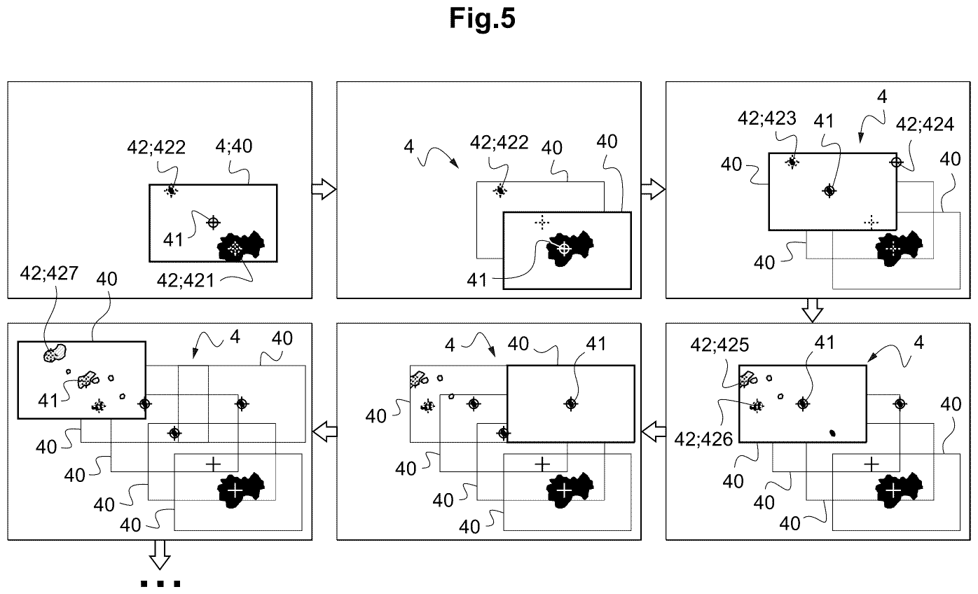

FIG. 5 illustrates the method described in relation with FIG. 4, and shows in particular an example of recording of several successive tiles in order to form a mosaic according to the second embodiment,

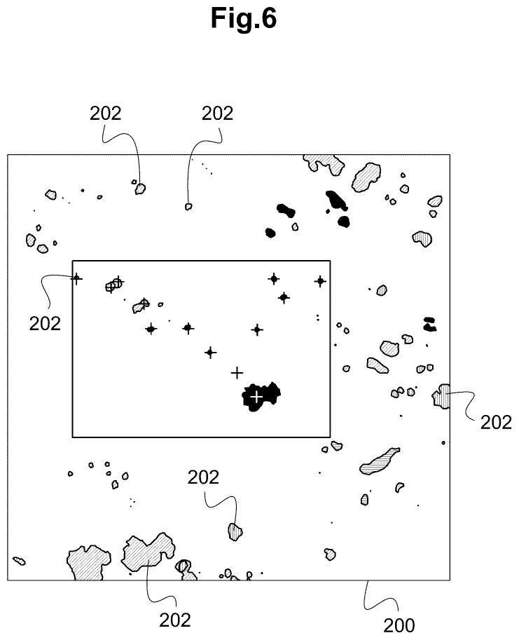

FIG. 6 shows an image of the sample of FIG. 3 or 5, inside which a position of the microparticles is located for some of the microparticles included in the mosaic of FIG. 3 or 5.

It is to be noted that, in these figures, the structural and/or functional elements common to the different alternatives can have the same references numbers.

Various other modifications may be made to the invention within the scope of the appended claims.

In FIG. 1 is shown a system 1 for spatial location in an image and spectral analysis of microparticles, based on an optical microscope, an image sensor 19, an image processing system 60 and a Raman spectrometer 19. Such a system is here called “optical microscopy system” and is based on light-matter interactions in order to image and/or analyse a sample 200 having structures of micrometric size. These structures are in particular in the form of microparticles 202, i.e. a solid particle whose size is for example between a few tenth of micrometres and a few hundredth of micrometres.

Here, the microparticles considered are microparticles 202 of plastic material, i.e. microparticles 202 of polymer, for example consisted of long carbon chain, and derived from fossil combustibles. Nevertheless, the term “microparticle” also refers, in a non-limiting way, to mineral grains of micrometric size, or also to pharmaceutical powder grains or to solid particles in suspension in the air.

These microparticles 202 are included in a sample 200 that has a size from a few hundreds of micrometres to a few tens of centimetres. The sample 200 is for example of macroscopic size and comprises microparticles 202 is suspension in water or in the air, or also takes the form a powder. Such a sample 200 is for example taken from an environment for the purpose of analysis and/or investigation in various domains such as food industry, pharmaceutical industry, geology and environmental sciences, to name but a few. The sample 200 taken is here put on a sample holder 20, in particular a glass microscope slide, and possibly protected by a microscope slide.

The system 1 for spatial location in an image and spectral analysis of microparticles schematically shown in FIG. 1 is thus configured to study such samples 200, in particular by making it possible to image the microparticles 202 contained therein, and thus to trace morphological information about these microparticles 202. It is for example possible to look at the area, perimeter, shape, etc., of these microparticles 202, via images recorded using this optical microscopy system 1. It is also advantageous to complete this morphological study with a study of the chemical composition of each of these microparticles 202, in particular via a recording of the spectra, for example Raman spectra or photoluminescence spectra, which are characteristics of the chemical composition. However, the recording of these characteristic spectra typically uses spot measurement methods.

It is particularly advantageous for studies on samples 200 of large size, enclosing microparticles 202, to proceed beforehand to a spatial location of these microparticles 202, in particular from a microscopy image, and to establish a characteristic spectrum on points located, most often, by a spot measurement on a point of micrometric dimensions. It is then possible to spatially solve information about a chemical composition of the sample 200. The term “large size” is used here to mean that the size of the sample is larger than the size of the microparticles 202, i.e. the sample 200 considered is of macroscopic size and has for example a side or a diameter of a few millimetres.

This initial location of the points of interest is time-saving, given the small size of the point on which the measurement can be made with respect to the total size of the sample 200. This is all the more true in the case of a sample 200 containing a low concentration of microparticles 202. Therefore, recording a spectrum only on the points of interest rather than making a spot measurement on each point of the sample 200 advantageously reduces the acquisition times, the processing times as well as the storage space required for storing the measured spectra.

The system 1 for spatial location in an image and spectral analysis of microparticles thus comprises at least two distinct microscopy modalities, each of the modalities being based on a contrast mechanism, i.e. of light-matter interaction and/or on implementation of a different light-matter interaction mechanism. Here, in the present disclosure, a dark-field microscopy modality is advantageously chosen to image the sample 200, associated with a Raman microspectroscopy modality, also sometimes referred to as Raman microspectrometry.

The dark-field microscopy modality is configured to illuminate a surface of the sample 200, and to acquire an image of at least part of this illuminated surface. Dark-field microscopy imaging, or more simply dark-field imaging, is based on the following contrast mechanism: the sample 200, and the structures included therein, as for example the microparticles 202, are lighted in such manner that only the light rays deviated by the sample 200 and the structures present on this sample 200, can be collected by an optical objective.

Dark-field microscopy is an imaging modality particularly adapted to the study of microparticles 202, in particular microparticles 202 of plastic material. Indeed, dark-field microscopy is known to exacerbate contrasts on transparent samples 200, i.e. those that absorb very little light. Now, certain plastic materials, and in particular microplastics and/or mineral or pharmaceutical powder grains are known to be transparent, and to have a relatively small contrast when they are illuminated using other imaging modalities, for example in clear-field lighting.

The system 1 for spatial location in an image and spectral analysis of microparticles comprises a second microscopy modality corresponding to a Raman microspectroscopy modality. This Raman microspectroscopy modality probes the chemical composition of the sample 200 at one measurement point, via the recording of a Raman spectrum emitted from this measurement point following a light excitation focused to this point. The Raman spectrum is obtained by Raman scattering, which corresponds to a phenomenon of inelastic scattering of light, due to an exchange of energy with the probed medium. This variation of energy is representative of the molecular vibration modes of the probed medium at the measurement point. The emitted Raman spectrum thus includes Raman lines. This Raman spectrum is characteristic of a given chemical species, and its measurement and analysis can, among other things, provide information on the chemical composition of a medium of interest.

Therefore, the Raman microspectroscopy modality advantageously allows point-by-point mapping, i.e. by scanning the measurement point, point by point, of the chemical composition of a sample 200, here more particularly the chemical composition of the microparticles 202 contained inside the sample 200. For example, it is possible to look at the composition of microparticles 202 of plastic material, dispersed inside an aqueous sample 200.

The implementation of each of these microscopy modalities is based on distinct illumination means and/or means for collecting a signal generated by light-matter interaction, whether it is in the form of an image or a spectrum.

It is proposed in the present invention a system 1 for spatial location in an image and spectral analysis of microparticles, inside which the two microscopy modalities, i.e. the dark-field microscopy modality and the Raman microspectroscopy modality, are implemented simultaneously, or successively, without requiring any mechanical switch between the two distinct illumination and/or detection means to switch from a modality to the other. Indeed, the mechanical switch commonly proposed in the optical microscopy systems to switch from a microscopy modality to another is a source of slowness when using the system. Although solutions to reduce time required to switch between two microscopy modalities exist, there are still problems linked to the high financial cost of these fast switching solutions, their potential misalignment, as well as their limited lifespan, due in particular to obsolescence of the motors driving such mechanical switching.

It is also described a dynamic analysis method benefiting from the system 1 for spatial location in an image and spectral analysis of microparticles as currently disclosed, particularly suitable for the imaging and spectral analysis of samples of large size, i.e. of macroscopic size, comprising microparticles 202. Indeed, in order to fully image such samples 200, the number of mechanical switching required to switch from a microscopy modality to the other, to locate the microparticles 202 before proceeding to their spectral analysis, is multiplied due to the size of the sample 200. Thanks to the method disclosed, the analysis of this type of sample 200 is accelerated, while keeping a high spatial resolution, and minimizing a storage space required for recording the data acquired.

The system 1 for spatial location in an image and spectral analysis of microparticles, shown in FIG. 1 and intended to analyse a sample 200 as described above, will be first described. In an example, the sample 200 is a sample comprising a dispersion of microparticles 202, such as mineral grains, or microplastics. Nevertheless, it may also be a sample comprising a solution or a liquid, for example aqueous, within which microparticles 202 of plastic material are dispersed. In any case, this sample 200 is placed on a sample holder 20. The optical microscopy system comprises for example a microscope stand, on which the different elements described in the following are arranged and attached.

A main axis 10 of the microscope is defined perpendicular to a plane of the sample 200, which is considered as flat.

The sample holder 20 is integral with a displacement stage 11 or positioning stage. The latter is adapted to move the sample holder 20 along at least two translation axes, an x-axis and a y-axis, the x and y axes being orthogonal to each other and parallel to the main plane of the sample 200. This displacement stage 11, for example a piezoelectric stage, is controlled by a controller (not shown in FIG. 1), and also motorized, so that the movements of the sample holder 20 can be automated. The displacement stage 11 has a displacement amplitude from a few tens of millimetres to a few centimetres, and a displacement accuracy in the micrometre range. A control unit 6, for example, a computer, pilots and synchronizes the displacements of the displacement stage 11.

### Dark-Field Microscopy Modality

In order to illuminate the sample 200 according to the dark-field microscopy modality, the system 1 for spatial location in an image and spectral analysis of microparticles comprises a light source. For example, it is a light source emitting an incoherent light radiation, such an incandescent lamp, a halogen incandescent lamp, or a lamp comprising at least one light-emitting diode (LED).

It is more precisely, in this first embodiment, an incandescent lamp emitting here a light radiation having a light spectrum covering at least partially the visible spectrum. Such a light radiation is then perceived as close to white, and it is then talked about a white light source 12.

The light radiation emitted by the white light source 12 here propagates in free space, in the form of a white light beam 120, this beam being collimated. It is supposed that the white light beam 120 propagates along an optical axis perpendicular to the main axis 10 of the microscope.

The optical microscopy system also comprises an annular mirror 13. This annular mirror 13 has a flat reflective surface, for example, a polished metal deposit on a flat surface. It is here for example a deposit of silver. This annular mirror 13 has an elliptic shape, which is pierced in its centre by a central opening of elliptic shape. In other words, the annular mirror 13 has the shape of an elliptic ring. The opening is centred on the surface of the annular mirror 13. Therefore, a central part of this annular mirror 13 does not reflects light. This annular mirror 13 is for example included in a block or cube, typically known as dark field cube.

A position of this annular mirror 13 is kept fixed with respect to the microscope stand.

This annular mirror 13 is arranged in such a way as to be, on the one hand, centred with respect to the main axis 10 of the optical microscopy system, and on the other hand, centred with respect to the white light beam 120. Moreover, the reflective flat surface of the annular mirror 13 forms an angle of 45 degrees with the main axis 10 of the microscopy system. The annular mirror 13 is then adapted to reflect part of the white light beam 122 towards the sample 200.

Indeed, if the white light beam 120 is initially approximated as a solid cylinder, only a portion corresponding to a hollow cylinder is reflected towards the sample 200. This portion corresponds to part of the white light beam 122 incident on the reflective flat surface of the annular mirror 13.

A remaining portion is transmitted through the central opening of elliptic shape of the annular mirror 13, for example towards a beam blocker, not shown in FIG. 1.

The part of the white light beam 122 corresponding to the hollow cylinder propagates along the main axis 10 of the optical microscopy system, towards the sample 200.

The optical microscopy system also includes a dark-field microscope objective 14, as known in the state of the art. Such an objective has to distinct optical regions, a peripheral region 142 and a central region 144. An optical axis of the dark-field microscope objective 14 is aligned with the main axis 10 of the microscopy system.

Here, in the embodiment described, the dark-field microscope objective 14 corresponds to an objective of magnification 50× and numerical aperture 0.60. A field of view of the dark-field microscope objective 14 is of 0.44 millimetres in diameter. Moreover, it is an infinity-corrected objective.

The peripheral region 142 of the dark-field microscope objective 14 corresponds to an external region surrounding the central region 144. The central region 144 corresponds to a conventional microscope objective. Therefore, the central region 144 is centred about the optical axis of the dark-field microscope objective 14, surrounded by the peripheral region 142.

The part of the white light beam 122 corresponding to the hollow cylinder is transmitted through the peripheral region 142 of the dark-field microscope objective 14. The sizes of the hollow cylinder, as well as that of the annular mirror 13, are chosen as a function of the size of the peripheral region 142. In particular, it is ensured that the whole part of the white light beam 122 reflected by the annular mirror 13 is transmitted through the peripheral region 142 of the dark-field microscope objective 14.

This peripheral region 142 opens to an annular optical element, that focuses the hollow cylinder into an annular light cone 124. This optical element corresponds for example to an annular optical lens, or to a concave mirror. That is using this annular lighting cone 124 corresponding to a hollow cone that the sample 200 is illuminated in the dark-field microscopy modality. The sample 200 is thus lighted using light rays highly oblique to the main axis 10 of the optical microscopy system, i.e. light rays having a large angle of inclination with respect to the main axis 10 of the optical microscopy system. An angle of inclination of the light rays is chosen so that these rays cannot be collected by the central region 144 of the dark-field microscope objective 14. Here, the angle of inclination takes values higher than or equal to 37 degrees with respect to the optical axis of the dark-field microscope objective 14.

An area of the sample 200 is thus illuminated. This area extends parallel to the plane of the sample 200, and a dimension, in particular a diameter, of this illuminated area, is determined as a function of the properties of the dark-field microscope objective 14, as for example its magnification, its numerical aperture.

The illuminated area considered here has a circular size going from a few micrometres to a few hundreds of micrometres in diameter. For example, the area considered here is a circular illuminated area of at least 100 micrometres in diameter, or even at least 140 micrometres in diameter, or even at least 150 micrometres in diameter. This circular illuminated area has a size, here a diameter, that is greater than a size of the image recorded afterwards.

Depending on the dark-field microscope objective 14 used in the first embodiment, the illuminated area corresponds to a circular area extending over a few tens, or even a few hundreds of micrometres. For example, the illuminated area corresponds to a circular area of 440 micrometres in diameter.

The sample 200, and in particular the structures contained therein, here microparticles 202, and more specifically microparticles 202 of plastic material and/or mineral microparticles 202, scatters part of the oblique light rays from the annular light cone 124. Only the light rays deviated by the structures of the sample 200 are collected by the central region 144 of the dark-field microscope objective 14, according to the known contrast mechanism of the dark-field microscopy. Therefore, only the structures that deviate at least partially the incident light produce a contrast, and contribute to a dark-field microscopy image. The central region 144 of the dark-field microscope objective 14 acts as a conventional microscopy objective, and is characterized by a magnification and a numerical aperture, as described hereinabove.

The light rays deviated by the microparticles 202 are hence collected by the central region 144 of the dark-field microscope objective 14. From a spectral point of view, these deviated light rays have a spectrum identical to that of the white light beam 120, because the contrast mechanism is based on a phenomenon of elastic scattering.

The deviated light rays emerge from the dark-field microscope objective 14 in a collimated state, because an infinity-corrected objective is used in the context of this first embodiment. These deviated light rays then propagate in free space along the main axis 10 of the optical microscope system, and pass in particular through the opening formed within the annular mirror 13.

An image sensor 15 then images the deviated light rays. This image sensor 15 has an optical axis that is aligned with the main axis 10 of the optical microscopy system, and thus by extension, with the optical axis of the dark-field microscope objective 14.

The image sensor 15 comprises an imaging optical system and a photosensitive matrix sensor 150, this unit being often referred to as a camera. The optical imaging system is adapted to make an image of the sample 200 on the photosensitive matrix sensor 150. The photosensitive matrix sensor 150 comprises a matrix, here rectangular, of light-sensitive pixels, and capable of converting light information into a cumulated electric charge. It is for example a CCD sensor or a CMOS sensor.

The image sensor 15 is adapted to record a dark-field microscopy image corresponding to at least part of the dark-field illuminated area, by imaging the deviated light rays on the photosensitive matrix sensor. The image sensor 15 has a field of view, depending among other things on a magnification of the optical imaging system of the image sensor 15 as well as on the size of the rectangular matrix of pixels. This field of view of the image sensor 15, as well as the field of view of the central region 144 of the dark-field microscope objective 14, limits a region of the sample 200 that can be imaged in the dark-field microscopy modality. This imaged region is called the image field of view.

The image field of view being included in the illuminated area, it is thus of smaller size than the size of the illuminated area.

The dark-field microscopy image reproduces the region of the sample 200 as described hereinabove, and the contrast inside this dark-field microscopy image represents the structures, i.e. the microparticles 202, as for example microparticles of plastic material, or mineral grains, capable of deviating incident light rays.

This dark-field microscopy image has most often a rectangular shape, due to the rectangular shape of the photosensitive matrix sensor 150.

Each dark-field microscopy image represents for example a region of 140 by 105 micrometres on the sample 200.

An image processing unit 60, shown in FIG. 1, and included for example in the control unit 6, here a computer, and is configured to exchange information with the image sensor 15. This image processing unit 60 is also adapted to identify and extract from the dark-field microscopy image coordinates of points that might correspond to microparticles 202. More particularly, microparticles 202 having a minimum diameter of 0.5 micrometres are spatially located, and morphological parameters are extracted therefrom. This minimum diameter depends in particular on the optical performances, i.e. the imaging performances of the system. There is no upper limit to the diameter of the detectable microparticles 202.

The image processing unit 60 is also configured to exchange with a user via an interface integrated in a software. The user has then the possibility to filter certain microparticles 202 of interest on the basis of specific criteria, such as the morphological parameters. For example, the user can choose to keep only the microparticles 202 having a diameter included between two value limits.

This identification and this extraction are made using a dedicated image processing algorithm, or also via an automatic learning or machine learning algorithm, as known in the state of the art. As an alternative, the identification and extraction of the coordinates of points of interest inside each dark-field microscopy image is made manually or partly manually by a user of the optical microscopy system.

### Raman Microspectroscopy Modality

The Raman microspectroscopy modality is also shown in FIG. 1.

Advantageously, this Raman microspectroscopy modality is operable without switching a mechanical element to switch from a modality to the other, and can thus be implemented simultaneously with the dark-field microscopy modality.

The optical microscopy system comprises a laser source 16. This laser source 16 emits an excitation laser beam 160, which is here continuous. The excitation laser beam 160 is moreover here collimated at the exit of the laser source 16.

In a non-limiting way, this laser source 16 corresponds for example to a diode-pumped solid state laser.

For the Raman microspectroscopy modality, the excitation laser beam 160 is monochromatic and has for example a wavelength chosen in a spectral window between 380 nanometres and 1064 nanometres. For example, it is here an excitation laser beam 160 having a wavelength of 532 nanometres.

At the exit of the laser source 16, this excitation laser beam 160 propagates along an optical axis of the beam, the optical axis of the laser beam being here initially parallel to the main axis 10 of the optical microscopy system. A first dichroic filter 17, also known in the state of the art as an edge filter, reflects the excitation laser beam 160 so that the optical axis of the laser beam is perpendicular to the main axis 10 of the optical microscopy system.

This first dichroic filter 17 corresponds more exactly to a high-pass filter. Such a filter is adapted to reflect a spectral range of wavelengths below a cut-off wavelength and to transmit another distinct spectral range of wavelengths, which this time is greater than the cut-off wavelength. The cut-off wavelength is chosen as a function of the wavelength of the excitation laser beam 160, here in such a way as to reflect the excitation laser beam 160. The first dichroic filter 17 has for example a cut-off wavelength established at 532.85 nanometres by the constructor.

As it corresponds to an edge filter, also known as the laser filter, a curve of the transmission as a function of the wavelength of this first dichroic filter 17 has a very reduced transition area between the transmitted wavelengths and the reflected wavelengths. In other words, the transmission curve of the first dichroic filter has a slope considered steep at its cut-off wavelength. In this case, a transition between the transmitted wavelengths and the reflected wavelengths takes place over a few nanometres around the cut-off wavelength. For example, the transition takes place over a width of 10 nanometres or less around the cut-off wavelength, more ideally over a width of 5 nanometres or less around the cut-off wavelength, or even a width of 3 nanometres or less around the cut-off wavelength.

The optical microscopy system also comprises a second dichroic filter 18.

Such second dichroic filter 18 is adapted to reflect a spectral range of wavelengths greater than a cut-off wavelength, and to transmit another distinct spectral range of wavelengths. It is thus a dichroic filter of the low-pass type.

Here, the cut-off wavelength is chosen to be less than the wavelength of the excitation laser beam 160, i.e. strictly less than 532 nanometres. More precisely, the second dichroic filter 18 has a cut-off wavelength equal to 495 nanometres. Therefore, the excitation laser beam 160 is reflected by the second dichroic filter.

This second dichroic filter 18 is also chosen to transmit at least part of the light spectrum of the white light beam 120. Advantageously, according to an embodiment, the light spectrum of the white light beam 120 is fully transmitted by the second dichroic filter 18.

This second dichroic filter 18 is centred on the main axis 10 of the optical microscopy system between the annular mirror 13 and the image sensor 15. It is also centred with respect to the optical axis of the excitation laser beam 160. A surface of the second dichroic filter 18 is oriented at 45 degrees to the optical axis of the laser beam, in order to reflect the excitation laser beam 160 along the main axis 10 of the optical microscopy system, towards the annular opening formed inside the annular mirror 13.

The excitation laser beam 160 is then transmitted through the hole of the annular mirror 13, along the main axis 10 of the optical microscopy system, towards the sample 200.

The central region 144 of the dark-field microscope objective 14, which is centred about the main axis 10 of the optical microscopy system, transmits the excitation laser beam 160 of the Raman microspectroscopy modality, before focusing this excitation laser beam 160 to a measurement point on the sample 200.

This measurement point is centred to the optical axis of the dark-field microscope objective 14, which is merged with the main axis 10 of the optical microscopy system. This point is for example merged with a geometric middle of the area illuminated in dark-field microscopy.

This measurement point has an extent in the xy-plane defined as a function the properties of the dark-field microscope objective 14, as in particular its numerical aperture, as well as the wavelength of the excitation laser beam 160.

Usually, the extent of the measurement point varies between a few hundreds of nanometres and a few micrometres. Here, for example, given the numerical aperture of the dark-field microscope objective 14, as well as the wavelength of the excitation laser beam 160, the measurement point probes a point of about 564 nanometres in diameter on the sample 200.

By Raman effect, the sample 200 emits a Raman spectrum, associated with an inelastically scattered light ray. The focus here is on the Stokes light radiation, corresponding to the light radiations whose wavelength is greater than or equal to the wavelength of the excitation laser beam 160.

This light radiation corresponds to the Raman spectrum emitted from the measurement point on which the excitation laser beam 160 is focused. This Raman spectrum includes in particular Raman lines, specific to the chemical composition of this measurement point. In order to access this spectral information, the scattered light radiation is analysed.

Thus, the Raman spectrum, in the form of a scattered light radiation, is collected by the central region 144 of the dark-field microscope objective 14, which collimates this scattered light radiation, into a light beam, called Raman beam 162. This Raman beam 162 is accompanied with a beam corresponding to the elastically scattered light radiations by Rayleigh scattering. This beam has the same wavelength as the excitation laser beam 160. This beam is hereinafter referred to as the Rayleigh beam.

The Raman beam 162 and the Rayleigh beam propagate along the main axis 10 of the optical microscopy system, towards the hole in the annular mirror 13.

The Raman beam 162, the Rayleigh beam and the excitation laser beam 160 are hence spatially merged, being collinear to each other. Nevertheless, the Raman beam 162 and the Rayleigh beam are counter-propagating with respect to the excitation laser beam 160, i.e. they propagate in opposite direction with respect to each other.

Therefore, the Raman beam 162 and the excitation laser beam 160 share an identical optical path between the sample 200 and the first dichroic filter 17.

The opening of the centre of the annular mirror 13 thus allows the Raman beam 162 and the Rayleigh beam collected and collimated by the central region 144 of the dark-field microscope objective 14 to pass through.

The Raman beam 162 and the Rayleigh beam continue their propagation up to the second dichroic filter 18. Given that the Raman beam 162 corresponds to the Stokes light radiation, of wavelength greater than or equal to the wavelength of the excitation laser beam 160, and thus strictly greater than the cut-off wavelength of the second dichroic filter 18, the Raman beam 162 is thus reflected, so as to form an angle of 90 degrees with respect to the main axis 10 of the optical microscopy system. It is the same for the Rayleigh beam, at the same wavelength as the excitation laser beam 160.

The Raman beam 162 and the Rayleigh beam thus propagate along the optical axis of the excitation laser beam 160 up to the first dichroic filter 17.

The first dichroic filter 17 transmits the Raman beam 162, towards a Raman spectrometer 19 included in the optical microscopy system, and reflects the Rayleigh beam. Indeed, this first dichroic filter 17 is configured to reflect the wavelengths smaller than or equal to the cut-off wavelength, chosen equal to that the excitation laser beam 160, while transmitting the wavelengths that are greater to it.

The Raman beam 162 is thus spectrally analysed by the spectrometer 19. Such a spectrometer 19 comprises in particular a dispersive element, i.e. an optical element adapted to spectrally decompose the light into monochromatic spectral components, such as a prism or a diffraction network, as well as a photosensitive matrix sensor 190, such as a CCD sensor or and CMOS sensor.

The spectral analysis of the Raman beam 162 by a spectrometer 19 enables to trace the Raman spectrum coming from the measurement point on which the excitation laser beam 160 has been focused by the central region 144 of the dark-field microscope objective 14.

Therefore, in the presently disclosed embodiment for the bi-mode optical microscopy system, i.e. a system associating here a dark-field microscopy modality for imaging with a Raman microspectroscopy modality, both modalities can be implemented simultaneously, without mechanical switching to switch from an illumination modality to another one.

According to a first alternative, in order to implement both modalities simultaneously, disjoint wavelength ranges are chosen for the light spectrum of the white light beam 120 and the wavelength of the excitation laser beam 160. In particular, in order to dissociate the Raman beam 162 coming from the Raman microspectroscopy modality from the deviated light rays coming from the dark-field microscopy modality, the light spectrum of the white light beam 120 is for example chosen strictly smaller than the wavelength of the excitation laser beam 160. In particular, a low-pass filter placed between the white light source 12 and the annular mirror 13 eliminates the undesirable wavelengths. As an alternative, a monochromatic radiation, of wavelength strictly smaller than the wavelength of the excitation laser beam 160 is chosen to act as a white light. Here, in the embodiment shown in FIG. 1, it is considered that the wavelength ranges covered by the laser source 16 and by the white light source 12 are disjoint. It is moreover considered that the wavelength range covered by the white light source 12 is strictly below the wavelength of the excitation laser beam 160.

Conversely, according to a second alternative, the two modalities can also be implemented in an alternating manner, i.e. one after the other, by controlling the power supply of one or both of the sources, i.e. laser source 16 and white light source 12. Thus, it is possible to selectively switch off one of the sources in favour of the other, in a quick manner, compared with conventional switching times known in the state of the art. In this case, the choice of spectral ranges covered by each of the two sources is free.

### Dynamic Method

Such an optical microscopy system finds a particularly advantageous application in the implementation of a method for spatial location and dynamic spectral analysis of microparticles 202 as described hereinafter. As a reminder, in such a dynamic approach, rather than imaging the sample 200 in its entirety, before proceeding to a spectral analysis as with a static approach, only a part of the sample 200 is imaged, before proceeding to the spectral analysis, inside the imaged part. These two steps are repeated until obtaining a representation of the sample 200 as a whole.

A first embodiment of such a method is described by a first block-diagram 3 shown in FIG. 2.

The method comprises the following steps in its first embodiment, these steps are detailed using an example in the following of the description:
illuminating 30 an area on the sample 200 using the dark-field microscopy modality,
recording 31 a dark-field microscopy image,
locating 32 microparticles 202 inside the image,
extracting 33 the coordinates of the points corresponding to these microparticles 202, in order to form a list,
moving 34 the sample 200, in order to make the central region 144 of the dark-field microscope objective 14 correspond with a point of the extracted list of coordinates,
illuminating 35 the sample 200 using the Raman microspectroscopy modality, the excitation laser beam 160 being focused at one measurement point that coincides with the point of the previous step,
collecting 36 the Raman spectrum, emitted from the measurement point, by the central region 144 of the dark-field microscope objective 14.

The moving 34, illumination 35 and collection 36 steps are then possibly repeated, for example until all the points on the list have been scanned, i.e. browsed. A new moving step 37 then moves the sample 200 to resume the method from the illumination 30, of a new dark-field area, at least partially distinct from the previous area.

An application of this first embodiment of the method is illustrated in FIG. 3.

In this first embodiment, a mosaic 4 representative of the sample 200 is reconstructed using a plurality of dark-field microscopy images. The mosaic 4 represents a field of greater size than the image field of view, thanks to an assembly of several dark-field microscopy images covering areas at least partially disjoint on the sample 200. Here, the images considered are dark-field microscopy images covering totally disjoint areas. Ideally, the mosaic 4 represents the whole surface of the sample 200.

Each of the images of the plurality of dark-field microscopy images is here called a tile 40, i.e. an area of the sample 200 extending in the xy-plane. Therefore, each of the tiles 40 is at least partially disjoint from the other tiles 40 included in the mosaic 4. Here, each of the tiles 40 is supposed to be totally disjoint from the other ones. The size of each of the tiles 40 is here identical, and defined by the field of view of the image sensor 15, this image field of view being included in the illuminated area of the sample 200.

Therefore, based on the characteristics of the image sensor 10 and of the dark-field microscope objective 14, each tile 40 has a rectangular shape of 140 micrometres by 105 micrometres.

In FIG. 3, the tiles 40 forming the mosaic 4 are arranged in a rectangular grid, in which the tiles 40 are each adjacent to each other.

In the first embodiment, a position of each tile 40 of the mosaic 4 is predefined upstream of the method execution with respect to a coordinate system. This coordinate system is for example represented by the displacement stage 11, which is integral with the sample holder 20 and hence the sample 200. Therefore, the coordinate system established by the displacement stage 11 also locate points on the sample 200.

Therefore, each of the tiles 40 is located by a pair of coordinated along x-axis and y-axis in the coordinate system. This pair of coordinates, denoted (xᵢ, yᵢ), positions a geometric centre 41 of the tile 40 with respect to the sample 200. The geometric centre 41 of the tile 40 here denotes a point of crossing of the diagonals of the tile 40, the latter having a rectangular shape. The geometric centre 41 is represented for each of the tiles 40 in FIG. 3, by a target, i.e. a cross and a circle.

As an alternative, each tile 40 can also be located thanks to one of its corners.

In the first embodiment, a set of coordinate pairs for each of the tiles 40 is pre-established beforehand, i.e. before the implementation of the presently disclosed method for spatial location and spectral imaging of microparticles 202. Each tile 40 occupies a predefined spatial extent on the sample 200.

Here, for the purpose of illustration, only a portion of the mosaic 4 reconstructed on the sample is shown in FIG. 3.

The portion of the mosaic 4 shown in FIG. 3 comprises twenty tiles 40, each of the tiles 40 having a size of 140 micrometres by 105 micrometres.

Usually, the considered samples 200 have dimensions of the order of about ten millimetres in diameter, such as 13 millimetres, 25 millimetres, or 42 millimetres, up to a few centimetres, represented by mosaics 4 of up to 1000 by 1000 tiles 40, i.e. one million of tiles 40, or even more.

For example, for a sample 200 having a size of 27 millimetres of diameter, it is necessary to acquire π*(D/2)² tiles, where D corresponds to the diameter of the sample 200, if the tiles 40 are of rectangular shape and each measure 100 micrometres by 100 micrometres. This represents approximately 58,000 tiles to be acquired, to pave the whole surface of the sample 200.

Tiles 40 of small size, corresponding to images acquired using high-magnification objectives, are preferable, in particular in order to increase a spatial resolution in the plane of the sample 200.

In order to record each of the dark-field microscopy images forming the tiles 40 of the mosaic 4, the displacement stage 11 moves the sample 200, in order, for example, to made a coordinate pair of the set of coordinate pairs pre-established for each of the tiles 40, here indicating the geometric centre 41 of each tile 40, coincide with the optical axis of the dark-field microscope objective 14. More generally, the matter is to make the field of view included in the area of the sample 200 illuminated by the dark-field microscopy modality coincide with the predefined tile 40.

Within the framework of a dynamic method for spatial location and spectral imaging of microparticles 202, coordinate points 42 associated with potential microparticles 202 are located inside each tile 40 imaged by the dark-field microscopy modality, and Raman spectra are recorded on these coordinate points 42 located thanks to the Raman microspectroscopy modality, before proceeding to the acquisition of the following tile 40. A successive order of the tiles 40 to be imaged is defined in advance, before the process is implemented. For example, the surface of the sample 200 is here imaged following a line-by-line scan pattern, also called raster scan, or following a serpentine sweep, or any other sweep pattern deemed appropriate.

Therefore, according to the first embodiment in which the positions of the tiles 40 are predefined, for each of the n tiles 40 forming the mosaic 4, the steps described hereinafter are implemented, with, between each of them, a moving 37 of the sample 200 to go from a tile to another.

The application of the method, for example for acquiring the tile 40 located in the top left-hand corner of the mosaic 4, as shown in FIG. 3, is now detailed.

Firstly, it is supposed that the geometric centre 41 defined for one of the tiles 40 corresponds to the optical axis of the dark-field microscope objective 14, after a positioning of the displacement stage 11.

For each tile 40, it is proceeded to an illumination 30 of an area of the sample 200 using the annular lighting cone 124. As a reminder, this lighting cone is generated by the reflection of part of a white light beam 120 by an annular mirror 13. The reflected part, forming a hollow cylinder, is transmitted by the peripheral region 142 of the dark-field microscope objective 14, and focused to the sample 200, so as to illuminate an area on the sample 200 only using light rays that are highly oblique in relation to the optical axis of the dark-field microscope objective 14.

A recording 31 of a first dark-field microscopy image, corresponding to one of the tiles 40 it then carried out using an image sensor 15. The rays deviated by the sample 200, in particular by the microparticles 202 contained therein, are collected by the central region 144 of the dark-field microscope objective 14, as described hereinabove. These deviated rays form the first dark-field microscopy image, in which a contrast is present only for the structures deviating the light, i.e. the microparticles 202. The first dark-field microscopy image is recorded on an image field of view included in the illuminated area of the sample 200. This first dark-field microscopy image corresponds to a first tile 40, here located in the top left-hand corner of the mosaic.

This dark-field microscopy modality optimises the contrast on samples 200 having a significant transparency, as here the microparticles 202 of plastic material, or on the mineral grains. This makes the next step easier.

Indeed, based on this first dark-field microscopy image, a location 32 inside this first image of the potential microparticles 202 is then carried out. This location 32 is for example carried out thanks to an image processing algorithm. In particular, it is possible to use shape detection, or contour detection, via such algorithms. As an alternative, the potential microparticles 202 are recognized using a machine learning algorithm. This machine learning algorithm, for example, a shape recognition algorithm, is trained beforehand using a base of images, in order to recognize some patterns of interest.

Once the potential microparticles have been identified in the first microscopy image, the process continues with an extraction 32 of the coordinates of the points possibly corresponding to microparticles 202 inside the dark-field image. This extraction is for example carried out by the image processing unit 60, using an image processing algorithm, of by a machine learning algorithm.

Therefore, for this first dark-field microscopy image corresponding to one of the tiles 40 of the mosaic 4, a list of points formed of coordinate points 42 is obtained. These coordinate points 42 are defined in the coordinate system of the displacement stage 11.

A coordinate point 42 is defined for each of the microparticles 202 located in the image field of view, for example placed at a geometric centre of each of the microparticles 202. In other words, each microparticle 202 appearing on the dark-field imaged tile 40 is associated with a single coordinate point 42.

The geometric centre of each of the microparticles 202 is located inside the latter, and is placed the farthest possible from the edges of the microparticle 202.

As an alternative, a multitude of coordinate points 42 can be extracted from a same microparticle 202 appearing in the first dark-field microscopy image. This multitude of points then takes the shape of a matrix of points, defined on each of the microparticles 202. A space between the coordinate points 42 extracted on a same microparticle 202 is defined as a function of a displacement accuracy of the displacement stage 11, and of a spatial resolution of the Raman microspectrometry modality. A fine mesh of each microparticle 202 is thus obtained. This thin mesh can then be used to measure a spectrum, here a Raman spectrum on each of the points of the matrix, and thus to realise a spectral map in order to access the chemical distribution inside the microparticle 202. As an alternative, it is also possible to average all the spectra acquired inside a given microparticles 202, in order to obtain an average spectrum representative of this microparticle 202.

Optionally, it is possible to perform a previous filtering of the microparticles 202 on which coordinate points 42 are extracted, as described above. For example, a filtering criterion is established on the basis of criteria linked to the morphological parameters based on the first dark-field microscopy image. They are for example size or shape criteria.

Here, the variant in which a single coordinate point 42 is extracted for each microparticle 202 appearing in the different tiles 40 is illustrated in FIG. 3. Each coordinate point 42 located on the different tiles 40 forming the mosaic 4 is shown using of a dotted-line cross.

Therefore, on the first dark-field microscopy image shown in the top left-handed corner in FIG. 3, three coordinate points 42 are extracted: a coordinate point 421, a coordinate point 422 and a coordinate point 423. These three points here form together the list of points for this tile.

A moving 34 of the sample, using the displacement stage 11, enables to make the optical axis of the dark-field microscope objective 14 coincide therewith. In other words, this moving 34 centres the central region 144 of the dark-field microscope objective 14, with a point from the list of points established in the previous step. For example, this is the coordinate point 421, shown in FIG. 3.

An illumination 33 of a measurement point on the sample 200 is then carried out using the Raman microspectrometry modality. For that purpose, an excitation laser beam 160 transmitted through the annular mirror 13 is focused by the central region 144 of the dark-field microscope objective 14.

Given that the measurement point is centred with respect to the optical axis of the dark-field microscope objective 14, the measurement point coincides with the point coming from the list of coordinate points. In other words, the excitation laser beam 160 is focused on the coordinate point 421.

The white light source 12 is then cut-off, via its power supply for example, the latter being connected to the control unit 6.

However, it is advantageous to keep simultaneously the two illumination modalities, above all when the displacement stage 11 is moved. Indeed, the simultaneous use of the lighting by the annular lighting cone 124 and the illumination of a measurement point by focusing the laser beam enables in particular to observe simultaneously the illuminated area on the sample 200 and the measurement point using the image sensor 15 of the dark-field microscopy modality. A very small portion of the excitation laser beam 160 passes through the second dichroic filter 18. This very small portion represents for example a portion of less than 0.001% of an optical power of this excitation laser beam 160. This portion is nevertheless sufficient to be observable on the image sensor 15. It is therefore possible to observe a relative position of the measurement point generated by the excitation laser beam 160 with respect to the dark-field illuminated area on the sample 200. The measurement point then appears as a small light point on the image field of view.

Therefore, if the disjoint wavelength ranges are chosen so that the white light beam 120 and the excitation laser beam 160, with the light spectrum of the white light beam 120 strictly below the wavelength of the excitation laser beam 160, then the two illuminations are maintained simultaneously, without risk of interference.

A step of collecting 36 a Raman spectrum emitted from the measurement point is then carried out. This spectrum is collected by the central region 144 of the dark-field microscope objective 14, and sent to the spectrometer 19 for analysis, along an optical path described in detail hereinabove. As for the illumination of the sample 200 by the excitation laser beam 160, the collection of the Raman spectrum requires no mechanical switching, which makes it possible to prevent a misalignment of the optical elements along this optical path.

The other coordinate points 422, 423 . . . extracted from the same dark-field microscopy image are also probed, in order to collect a Raman spectrum. For that purpose, a moving 34 of the sample 200 is operated, via the displacement stage 11, in order to make the measurement point coincide successively with each of the other coordinate points 422, 423 . . . from the list of points of the considered tile. Therefore, within the framework of the example illustrated, the displacement stage 11 moves the sample 200 in order to scan the coordinate point 422, then the coordinate point 423. A scanning pattern within the tile 40 is illustrated by arrows.

A Raman spectrum is collected at each of the points from the list of points, by a moving 34 of the displacement stage 11 followed with the collection 36 of a spectrum.

These two collecting 36 and moving 34 steps are applied recursively for all the coordinate points 42 from the list of points extracted from the first dark-field microscopy image, i.e. extracted from the first tile 40.

After all the coordinate points 42 from the list of points of the first tile 40 have been scanned, a new dark-field microscopy image is recorded as part of the process. For that purpose, a moving 37 of the sample makes one of the geometric centres, a pair of coordinates of which has been predefined, coincide with the optical axis of the dark-field microscope objective.

The list of points is then reset.

This new dark-field microscopy image corresponds to a following tile 40 of the mosaic 4, defined according to the scanning pattern chosen. Here, it is for example the tile on the right of the first tile 40 described hereinabove, i.e. on the first line and second colon of FIG. 3.

The succession of steps previously described is repeated for this next tile 40, and for all the tiles 40 included in the mosaic 4, until obtaining a spectral image representative of the full sample 200. Such a spectral image is shown in FIG. 6.

On this spectral image, the visible structures, here corresponding to microparticles 202, are imaged thanks to the dark-field microscopy modality, whereas colours, here represented by textures, are associated with each of the microparticles 202. These colours indicate the chemical nature, i.e. the composition, of the microparticles 202, which correspond in the example illustrated in FIG. 6, in a non-limiting way to microparticles 202 of mineral material, here more particularly chalk. These colours moreover correspond to false colours, chosen arbitrarily, as a function of the chemical composition of the microparticle. The composition of each microparticle 202 is determined by the analysis of the spot Raman spectra collected by the Raman microspectrometry modality, in particular based on the Raman lines present in the collected spectrum.

In practice, the Raman spectrum of each of the microparticles 202 is identified and assigned to a class via dedicated algorithms. For example, and in a non-limiting way, it is for example possible to identify the chemical composition of a microparticle 202 by correlation between the spectrum acquired on the microparticle 202 and a pre-established base of spectral data stored in memory. The microparticle 202 is then identified as corresponding to the known chemical species whose spectrum has the closest correlation.

It is also possible to carry out a multivariate analysis, for example thanks to a Multivariate Curve Resolution (MCR). Such a multivariate analysis makes it possible to distribute the microparticles 202 into different classes, these latter being then identified manually or automatically.

According to another alternative, identification of the chemical composition of the microparticles 202 is made via machine learning. A model is then trained beforehand on a great number of labelled data, to then allow identifying the spectrum of the microparticle 202 to be characterized.

Thus, for each tile 40 obtained and corresponding to a dark-field microscopy image, spectral information associated with the imaged microparticles 202 in the tile 40 is extracted. Such spectral information then enables tracking the chemical nature of these microparticles 202.

The dynamic acquisition method as described in the first embodiment offers in particular the following advantages:

Firstly, morphological parameters of the microparticles 202 are determined on the fly, during the tile-by-tile reconstruction of the mosaic 4. It is therefore possible to fully exploit the spatial resolution of the dark-field microscopy modality during the determination of the morphological parameters. This has for effect to improve the accuracy of this determination. Indeed, in the static mode mentioned in the preamble, the resolution of the dark-field microscopy image has to be compressed during the acquisition in order to limit the memory space required for storing these dark-field images.

Moreover, the spectral analysis is also made on the fly, during the tile-by-tile reconstruction of the mosaic 4. The movement performed by the displacement stage 11 to position on each of the microparticles is thus small, of the order of a few micrometres. Now, the accuracy of a displacement stage 11 is usually given in micrometres per millimetres, typically 3 micrometres per millimetres. Thus, a movement of the order of a few micrometres is more accurate than a movement of several millimetres. Given that the system described here is applied to objects of study of micrometric dimensions, an accuracy of the same order of magnitude, i.e. of micrometric order becomes critical. Thus, the method provides a gain in terms of spatial resolution when the measurement using the Raman microspectrometry modality. Within the framework of a static method, as described in preamble, the sample 200 is imaged on its whole surface, typically a region of one centimetre by one centimetre, before returning to scan the points of interest on microparticles 202 using the Raman microspectroscopy modality. This causes a positioning error of potentially several micrometres.

Moreover, the dynamic approach as described in the first embodiment also makes it possible to limit the inconvenience caused by variations in environmental conditions encountered in static mode. Indeed, the acquisition of a full mosaic 4 using the dark-field microscopy modality requires several tens of minutes, or even an hour. Therefore, it is possible that the environmental conditions, such as temperature, humidity and vibration, vary and generate inaccuracy of the measurement during the switching between the dark-field microscopy modality and the Raman microspectroscopy modality. The dynamic mode, described here via two embodiments, allows the two modalities to be linked together in a short space of time, or even allows the two modalities to be implemented simultaneously. Thus, the system is made insensitive to the environmental variations that take place over long time scales.

In addition to these advantages with respect to the static approach, the present invention avoids the idle times corresponding to the mechanical switching times to switch from one modality to another inside a tile 40. Indeed, the switching from the dark-field microscopy modality, and the Raman microspectroscopy modality, is made without switching of mechanical elements, thanks to the previously described system. Therefore, no mechanical switching time is required, which represents a significant time saving.

Indeed, for microscopy applications, high-accuracy mechanical switching systems are used. Usually, such mechanical switching systems require a few seconds, for example 6 seconds, to switch from the dark-field microscopy modality to the Raman microspectrometry modality, and a few seconds, for example 6 seconds, to perform the switching in the opposite direction, that is as much time wasted on each tile 40 imaged. Here, 12 seconds are lost per imaged tile 40. At the scale of the mosaic 4 representing a sample 200 of large size, i.e. of the order of a few centimetres by a few centimetres side, comprising several hundreds of tiles 40, or even millions of tiles 40, that is a significant measurement time that is lost that way.

Even for more powerful mechanical switching systems, which by extension are also more expensive, it remains a mechanical switching time of a few hundreds of microseconds. In reality, even on such mechanical switching systems, it remains a mechanical switching time of the order of a few milliseconds. At the scale of a sample 200 of large size, these switching times are not negligible.

The proposed method implemented by the described system 1 for spatial location in an image and spectral analysis of microparticles thus provides time saving on the analysis of samples of large size, i.e. a few tens of millimetres side, or even a few centimetres and comprising microparticles 202 of low contrast.

### The “Tom Thumb” Method

A second embodiment of the disclosed method is illustrated by a block-diagram 5 in FIG. 4.

This block-diagram 5 comprises the following steps, as an initialisation:
illuminating 50 an area on the sample 200 using the dark-field microscopy modality,
recording 51 a dark-field microscopy image,
locating 52 microparticles 202 inside the image,
extracting 53 the coordinates of the points corresponding to these microparticles 202, in order to form a list,
moving 54 the sample 200, in order to make the central region 144 of the dark-field microscope objective 14 correspond with a point of the extracted list of coordinates,
illuminating 55 the sample 200 using the Raman microspectroscopy modality, the excitation laser beam 160 being focused at one measurement point that coincide with the point of the previous step,
collecting 56 the Raman spectrum, emitted from the measurement point, by the central region 144 of the dark-field microscope objective 14.

Once initialized, the method according to the second embodiment is continued by moving 54 the sample, in order to make the optical axis of the dark-field microscope objective 14 correspond with another point of the extracted list of coordinates. Thereafter, the steps of illuminating 50, recording 51, locating 52 using the dark-field microscopy modality being executed, in parallel, or before, or after steps of illuminating 55 and collecting 56 using the Raman microspectroscopy modality.

The method is therefore looped to the moving step 54, for example, as long as the list of points contains coordinate points 42 that have not yet been scanned and measured by Raman microspectroscopy.

In this second embodiment, a mosaic 4 representative of the sample 200 is reconstructed using a plurality of dark-field microscopy images, like what had been described for the first embodiment. Therefore, this mosaic 4 represents a larger field than the field of view of a dark-field microscopy image. This mosaic 4 is composed of tiles 40, i.e. of dark-field microscopy images arranged so as to reproduce the analysed sample 200. In the second embodiment, some of these tiles 40 overlap at least partially. In other words, some of the tiles 40 of the mosaic 4 partly cover spatially identical areas.

As in the first embodiment, according to the characteristics of the image sensor 15 and of the dark-field microscope objective 14 used to collect a dark-field microscopy image, each tile 40 has a rectangular shape of 140 micrometres by 105 micrometres.

A portion of mosaic 4 obtained according to the second method is reproduced in FIG. 5. A rectangle indicates the delimitations of the portion of mosaic 4 of FIG. 3, this rectangle being also reproduced in FIG. 6.

In this embodiment, the geometric centres 41 of the tiles 40 are not predefined. Likewise, the arrangement of the tiles 40 relative to each other is not defined upstream of the process. Indeed, in this second embodiment, pairs of coordinates for defining the position of each tile 40 are defined during the process, based on information collected during the implementation of the process.

More specifically, geometric centres 41 are chosen based on coordinate points 42 extracted during this process, which causes the acquisition of new dark-field microscopy images, and the extraction of new coordinate points 42. These new coordinate points 42 become potentially themselves geometric centres 41 for tiles 40, and so on.

Hence, unlike the first embodiment, moving from one tile 40 to another tile 40 does not necessarily involve a dedicated move, and a tiling of the mosaic 4 is carried out as the moves 54 are done. These moves 54 aim to scan the different coordinate points 42 from the list of points, which then form geometric centres 41 for tiles 40.

The step previously described for the second embodiment of the method will now be described in detail thanks to the example of FIG. 5.

In order to start the process, the displacement stage 11 places the sample 200 at an arbitrary position. For example, a geometric centre 41 of a first tile 40, shown in FIG. 5, is chosen here at mid-travel by a displacement amplitude of the displacement plate 11 along x-axis and along y-axis. This position corresponds to a middle of the displacement stage 11.

The following step of the method consists in an illumination 50 of an area of the sample 200 according to the dark-field microscopy modality. As described hereinabove, the illumination 50 of the area of the sample 200 centred around the geometric centre 41 of the first tile 40 is made by an annular lighting cone 124, focused to the sample 200 by the peripheral region 142 of the dark-field microscope objective 14.

In FIG. 5, the geometric centre 41 of each tile 40 is indicated by a solid-line target, i.e. a cross surrounded by a circle.

The illumination 50 of this area by the dark-field microscopy modality leads to a recording 51 of a first dark-field microscopy image. Once again, the field of view of this image is included in the illuminated area of the sample 200. This first dark-field microscopy image is obtained by the central region 144 of the dark-field microscope objective 14 collecting the deviated light rays.

Based on this first dark-field microscopy image, a location 52 of the potential microparticles 202 inside the first image is carried out. This location 52 is supposed to be identical to that described for the first embodiment.

After having located the potential microparticles 202 contained in the image field of view, for example, thanks to a dedicated image processing algorithm, an extraction 53 of the coordinates of the points corresponding to potential microparticles 202 is carried out. This extraction 53 is carried out as described hereinabove, by the processing unit, using suitable algorithms, and/or by a user. Like with the first embodiment, a single coordinate point 42 is associated with each of the microparticles 202 viewed in dark-field, even if alternatives are possible.

These extracted coordinate points 42 are added to a list of points.

In the first tile 40, two coordinate points 42 are extracted, the coordinate 421 and the coordinate point 422. These coordinate points 42 are indicated in FIG. 5, using dotted-line targets.

A moving 54 of the sample 200 by the displacement stage 11 makes the optical axis of the dark-field microscope objective 14 coincide with coordinate points from the list of points. In particular, a point is chosen that has not yet been scanned by the Raman microspectroscopy modality. For example, this is here the coordinate point 421, that corresponds to the coordinate point 421 associated with the first microparticles 202 identified and located inside the tile 40.

The following step comprises illuminating 55 a measurement point on the sample 200 using the Raman microspectrometry modality. The laser beam is focused on the sample 200, at a measurement point, by the central region 144 of the dark-field microscope objective 14. The measurement point is here in the continuation of the optical axis of the dark-field microscope 14.

Therefore, the moving 54 makes the illuminated measurement point coincide with the coordinate point 421 taken from the list of points.

After illumination 55 and moving 54, collection 56 of a Raman spectrum emitted from the measurement point is carried out, this Raman spectrum being collected by the central region 144 of the dark-field microscope objective 14.

Advantageously, given that non mechanical switching is required to switch from a modality to another, it is possible to proceed to a new recording 50 of a new tile 40, the geometric centre 41 of which is merged with one of the coordinate points 42 coming from the list of points L.

Here, in the example shown in FIG. 5, the geometric centre 41 of the new tile 40 is merged with the coordinate point 421. This point is indicated by a solid-line target, as long as the geometric centre 41 of the first tile 40 is indicated by a dotted-line cross.

In a first alternative to this second embodiment, to acquire a new tile 40, if the spectral ranges of the laser source 16 and the white light source 12 are disjoint, and if the components of the white light spectrum have a wavelength below the wavelength of the excitation laser beam 160, then the two illuminations are used simultaneously. It is assumed that this is the case presented here.

An illumination 55 of a measurement point by the excitation laser beam 160, followed with the collection 36 of the Raman spectrum emitted, and a recording 51 of the new dark-field microscopy image, whose field of view is included in the illuminated area of the sample 200, are thus both carried out, as described above.

This recording 51 is followed with a location 52 of the microparticles 202, an extraction 53 of the coordinates of the points corresponding to microparticles 202. Here, no point corresponding to a microparticle 202 is detected.

According to a second alternative, after the moving 54, the illumination 50, the recording 51, the location 52 and the extraction 53 are first carried out according to the dark-field imaging modality, then the illumination 55 and the collection 56 are carried out according to the Raman spectrometry modality.

Regardless of the order of use of the two modalities, the method is continued with the moving 54 of the sample, in order to make the measurement point coincide with another point from the list of points L.

It is here the coordinate point 422, as shown in FIG. 5. This coordinate point 422 then becomes the geometric centre 41 of a new tile 40. It is here the third tile 40 that is imaged.

The steps of the method are then repeated, via a potential illumination 50, a recording 51 of a new dark-field microscopy image that forms the third tile 40, a location 52 and an extraction 53 of the coordinates of the points corresponding to potential microparticles 202, these steps being here executed in parallel to the steps of illuminating 55 the measurement point by the excitation laser beam and collecting 56 the Raman spectrum. Here, in particular, the coordinate point 423 and the coordinate point 424 are detected and extracted from the third tile 40. These coordinate points 423 and 424 are added to a list of points to be scanned.

A new move 54 of the stage then places the measurement point on one of the points from the list of points, and the described steps of the method are hence repeated.

The mosaic 4 representative both of the structures and the chemical nature of the sample 200 is therefore reconstructed on the fly. In other words, the list of points L is updated in continuous during the implementation of the method, and is not reset between each tile 40.

A fourth tile 40, corresponding to a fourth dark-field microscopy image, is acquired with the coordinate point 423 as the geometric centre 41. The coordinate points 425 and 426 are extracted from this fourth image, and the displacement stage 11 moves the sample 200 in such a way as to probe the coordinate point 424 using the Raman microspectrometry modality. The coordinate point 424 becomes the geometric centre 41 of a fifth tile 40, for which the steps of the method are repeated. The coordinate point 425 from the list of points L is then scanned, in order to collect both a Raman spectrum, but also a sixth dark-field microscopy image corresponding to a sixth tile 40. The coordinate point 427 is then extracted from this sixth image.

The method results in a spectral image corresponding to a mosaic 4 representing the whole surface of the sample 200. This spectral image is shown in FIG. 6, i.e. it corresponds to the same spectral image as that obtained with the first embodiment described above.

The structures of the microparticles 202 are obtained using the dark-field microscopy modality, which highlights contrasts even on these highly transparent samples 200, while the false colours are associated with a composition determined by analysis of the Raman spectrum.

Within the framework of this second embodiment, the simultaneity of the two illuminations is exploited in order to use the movements required for probing the points of interest by the Raman microspectroscopy modality, also to image the sample 200 by dark-field microscopy.

A scanning order of coordinate points 42 from the list of points L is chosen for example so as to minimize the distances travelled by the stage during a movement. For example, it is advantageous to minimize the Euclidean distance between two coordinate points 42 scanned successively. It is also possible to chose to minimize a total moving distance required to scan all the coordinate points 42.

This scanning order is therefore reorganised during the process, in particular if new coordinate points 42 are extracted.

A suitable protocol can also be implemented, in case there is no coordinate points 42 in the list of points L that has not yet been scanned. For example, it is then decided to move the sample 200 by a sufficient quantity to probe a new area of the sample 200.

This second embodiment has the same advantages as the first embodiment described, in particular by eliminating the prohibitive mechanical switching times when switching from the dark-field microscopy modality to the Raman microspectroscopy modality.

### Alternative Embodiments

The present invention is not in any way limited to the embodiments described and shown, but the person skilled in the art will know how to apply any variant in accordance with the invention.

1. A method for spatial location in an image and spectral analysis of microparticles in a sample by an optical microscopy system, the method comprising the following steps:
A) illuminating an area of the sample using an annular lighting cone, the annular lighting cone coming from a white light beam partly reflected by an annular mirror and focused by a peripheral region of a dark-field microscope objective,
B) recording a first dark-field microscopy image on a field of view included in the illuminated area of the sample, the first dark-field image being collected by a central region of the dark-field microscope objective,
C) locating the microparticles in the first dark-field image,
D) extracting the coordinates of the points corresponding to microparticles inside the dark-field image recorded, so as to form a list of points,
E) moving the sample to make an optical axis of the dark-field microscope objective coincide with a point on the list of points,
F) illuminating a measurement point on the sample using an excitation laser beam transmitted through the annular mirror and focused by the central region of the dark-field microscope objective, the measurement point coinciding with the point from the list of points,
G) collecting a Raman spectrum emitted from the measurement point, the Raman spectrum being collected by the central region of the dark-field microscope objective.

2. The method according to claim 1, wherein steps A) and F) are carried out simultaneously, an area is illuminated on the sample by the peripheral region of the dark-field microscope objective, whereas a measurement point inside the area is illuminated by the central region of the dark-field microscope objective.

3. The method according to claim 1, wherein a field of greater size than the image field of view is reconstructed by a mosaic of dark-field microscopy images, these dark-field microscopy images corresponding to tiles of the mosaic.

4. The method according to claim 3, wherein a positioning of each tile of the mosaic is predefined upstream of the process.

5. The method according to claim 4, wherein steps E), F) and G) are repeated until all points of the extracted list of points have been scanned on a given tile, before proceeding to a step of moving the sample in order to centre the field of view of the dark-field microscope objective to another tile of the mosaic and to resume the process from step A), in order to record another dark-field microscopy image.

6. The method according to claim 5, wherein, for each tile of the mosaic, the list of points includes a determined number of points.

7. The method according to claim 3, wherein a positioning of at least one tile of the mosaic is established as a function of the coordinates of a point from the list of points.

8. The method according to claim 7, wherein, after the moving of step E) to make the optical axis of the dark-field microscope objective coincide with a point on the list of points, steps A), B), C), D), F) and G) are carried out, a new dark-field microscopy image, corresponding to a new tile of the mosaic, and a Raman spectrum emitted from the measurement point, are recorded, these steps being followed by another moving of the sample to make the optical axis of the dark-field microscope objective coincide with another point from the list of points.

9. The method according to claim 8, wherein additional points extracted from the new dark-field microscopy image recorded after the moving of step E) are added to the list of points to be scanned.

10. A system for spatial location in an image and spectral analysis of microparticles, comprising an optical microscope, a laser source, a white light source, an image sensor, a spectrometer and a control unit, the latter comprising an image processing unit, the optical microscope comprising a sample holder mounted on a displacement stage, the sample holder being adapted to receive a sample,
wherein the system comprises:
an optical system comprising an annular mirror and a dark-field microscope objective, the optical system being arranged between the laser source, the white light source and the sample holder, the dark-field microscope objective having a central region and a peripheral region,
the annular mirror is configured to reflect part of white light beam emitted by the white light source towards the peripheral region of the dark-field microscope objective, and transmit an excitation laser beam emitted by the laser source towards the central region of the dark-field microscope objective,
the dark-field microscope objective is adapted to transmit the part of the white light beam using its peripheral region towards the sample holder and to transmit the excitation laser beam via its central region towards the sample holder,
the dark-field microscope objective is adapted to focus the part of the light beam in order to illuminate a first area of a sample on the sample holder using an annular lighting cone and the dark-field microscope objective is adapted to focus the excitation laser beam to a measurement point included in the first area,
the central region of the dark-field microscope objective is adapted to collect a dark-field microscope image on an image field of view included in the first illuminated area, the dark-field microscope image being recorded using the image sensor,
the image processing unit is adapted to locate potential microparticles, and to extract from the dark-field microscope image coordinates of the points associated with these microparticles, in order to establish a list of points,
the displacement stage is configured to move the sample holder, in order to make the measurement point coincide with a point from the list of points or in order to place the image field of view of the dark-field microscope objective to another area at least partially different from the first area;
the central region of the dark-field microscope objective is also adapted to collect a Raman spectrum generated from the measurement point, the Raman spectrum being recorded by a Raman spectrometer.

11. The method according to claim 2, wherein a field of greater size than the image field of view is reconstructed by a mosaic of dark-field microscopy images, these dark-field microscopy images corresponding to tiles of the mosaic.
